(19) United States
(12) Patent Application Publication
(10) Pub. No.: US 2018/0116882 A1
(43) Pub. Date: May 3, 2018

(54) Wheelchair Safety System

(71) Applicant: Benjamin Shaw, Fort Wayne, IN (US)

(72) Inventor: Benjamin Shaw, Fort Wayne, IN (US)

(21) Appl. No.: 15/341,208

(22) Filed: Nov. 2, 2016

(51) Int. Cl. A61G 5/10; F21V 21/22; F21S 8/10; B60Q 1/00; B60Q 1/26; F21V 14/02

(52) U.S. Cl. CPC A61G 5/10; F21V 21/22; F21V 14/02; B60Q 1/0076; B60Q 1/2615; F21S 48/2212

(57) ABSTRACT

A wheelchair safety system for enhancing visibility of a wheelchair includes a wheelchair that has a body and a battery. A light unit is coupled to the wheelchair and the light unit emits light. Thus, the light unit notifies traffic that the wheelchair is crossing a roadway. The light unit has a telescopically adjustable height.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to safety devices and more particularly pertains to a new safety device for enhancing visibility of a wheelchair.

### BRIEF SUMMARY OF THE INVENTION

An embodiment of the disclosure meets the needs presented above by generally comprising a wheelchair that has a body and a battery. A light unit is coupled to the wheelchair and the light unit emits light. Thus, the light unit notifies traffic that the wheelchair is crossing a roadway. The light unit has a telescopically adjustable height.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a wheelchair safety system according to an embodiment of the disclosure.

FIG. 2 is a bottom view of an embodiment of the disclosure.

FIG. 3 is a front phantom view of an embodiment of the disclosure.

FIG. 4 is a right side view of an embodiment of the disclosure.

FIG. 5 is a perspective in-use view of an embodiment of the disclosure.

### DETAILED DESCRIPTION OF THE INVENTION

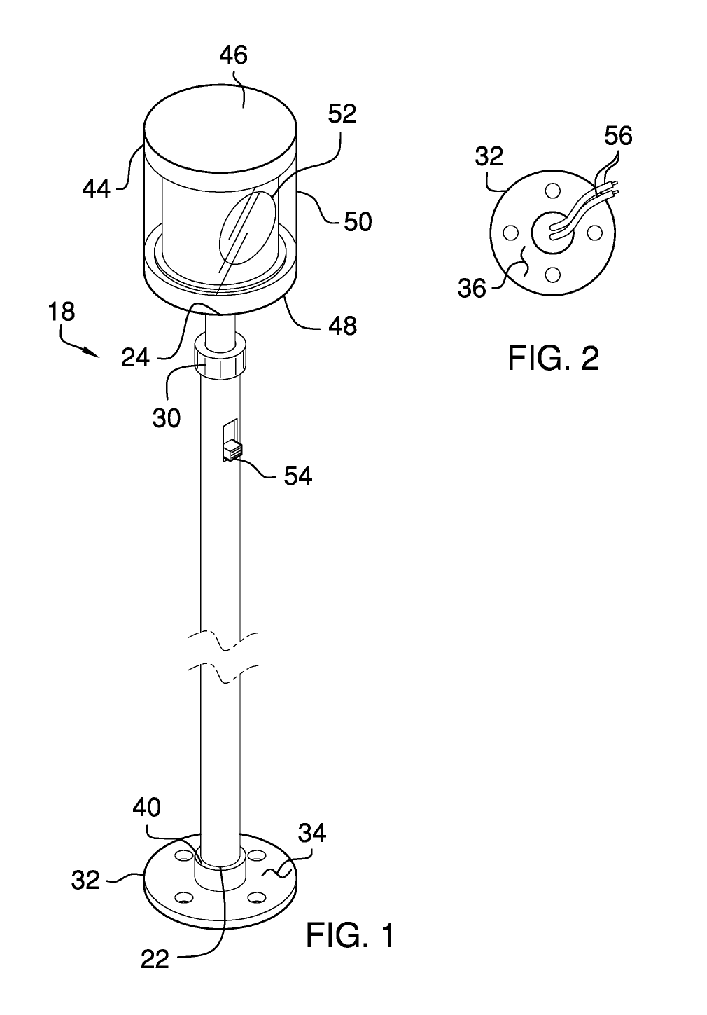

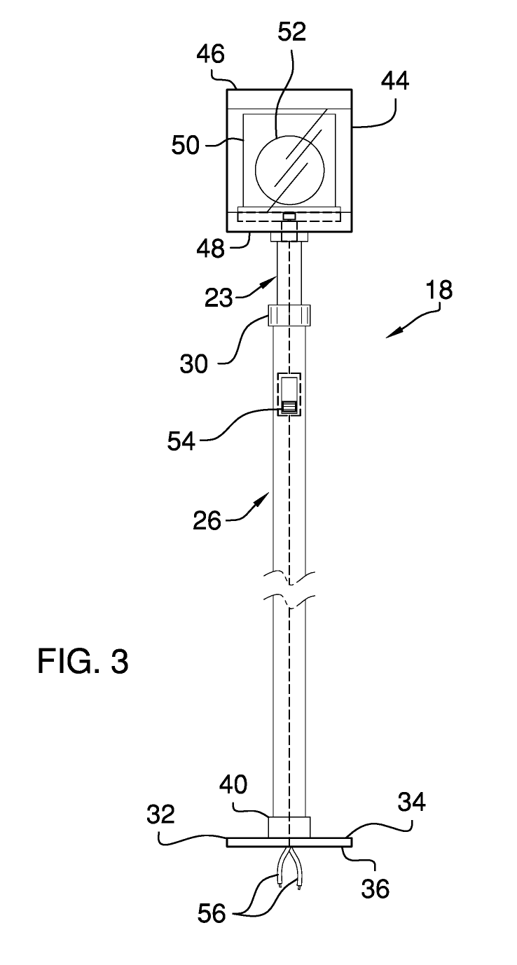

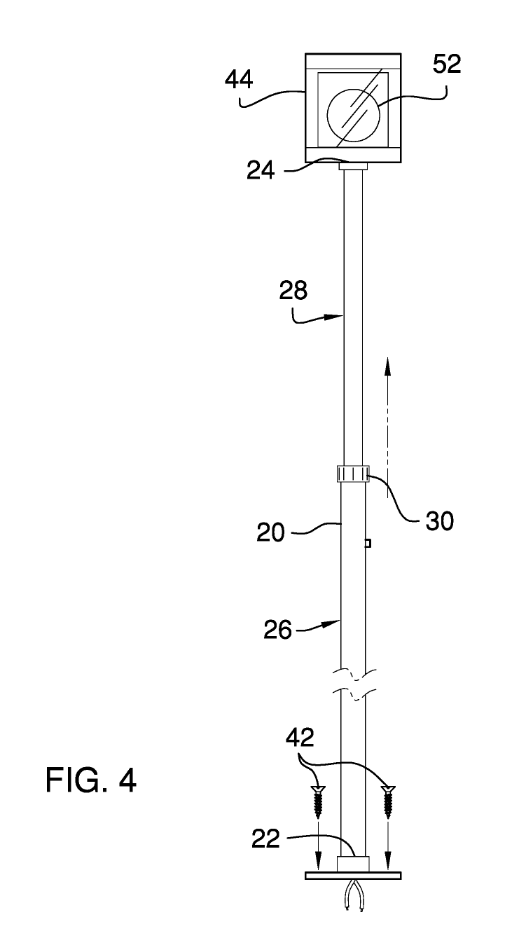

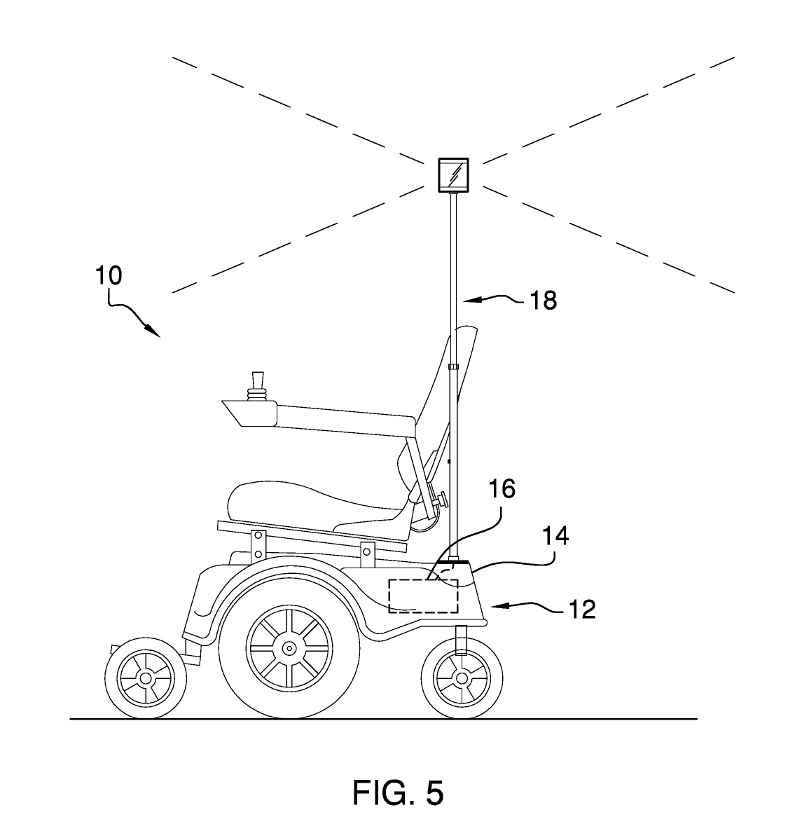

With reference now to the drawings, and in particular to FIGS. 1 through 5 thereof, a new safety device embodying the principles and concepts of an embodiment of the disclosure and generally designated by the reference numeral 10 will be described.

As best illustrated in FIGS. 1 through 5, the wheelchair safety system 10 generally comprises a wheelchair 12 that has a body 14 and a battery 16. The wheelchair 12 may be an electric wheelchair 12 of any conventional design. A light unit 18 is provided and the light unit 18 is coupled to the wheelchair 12. The light unit 18 emits light thereby facilitating the light unit 18 to notify traffic that the wheelchair 12 is crossing a roadway. Moreover, the light unit 18 has a telescopically adjustable height. Thus, the light unit 18 is visible to traffic.

The light unit 18 comprises a rod 20. The rod 20 has a first end 22 and a second end 24. The rod 20 comprises a first half 26 that is slidably coupled to a second half 28. Thus, the rod 20 has a telescopically adjustable height. A coupler 30 is rotatably coupled around the first half 26 and the coupler 30 may be manipulated. The coupler 30 frictionally engages the second half 28 to retain the rod 20 at a selected height.

A base 32 is provided. The base 32 has a first surface 34 and a second surface 36. The base 32 has a plurality of openings 38 extending through the first surface 34 and the second surface 36. A collar 40 extends upwardly from the first surface 34 of the base 32. The first end 22 of the rod 20 is positioned in the collar 40 such that the rod 20 is coupled to the base 32. The second surface 36 abuts the body 14 of the wheelchair 12.

A plurality of fasteners 42 is provided. Each of the fasteners 42 extends through an associated one of the openings 38 and engages the body 14. Thus, the base 32 is retained on the wheelchair 12. Each of the fasteners 42 may be a screw or the like.

A housing 44 is provided that has a top wall 46, a bottom wall 48 and an outer wall 50 extending therebetween. The outer wall 50 is continuous such that the housing 44 has a cylindrical shape. The outer wall 50 is comprised of a translucent material. The bottom wall 48 is coupled to the second end 24 of the rod 20. Thus, the housing 44 is spaced a selected distance above the wheelchair 12 to enhance visibility of the housing 44 with respect to the traffic.

A light emitter 52 is provided. The light emitter 52 is rotatably positioned within the housing 44. Thus, the light emitter 52 emits light outwardly from the outer wall 50. The light emitter 52 may be rotating emergency light emitter 52 or the like. Moreover, the light emitter 52 may emit blue light.

A switch 54 is provided. The switch 54 is coupled to the rod 20 and the switch 54 may be manipulated. The switch 54 is electrically coupled to the light emitter 52. Thus, the switch 54 turns the light emitter 52 on and off.

A pair of conductors 56 is provided. Each of the conductors 56 extends through the first end 22 and the second end 24 of the rod 20. Each of the conductors 56 is electrically coupled between the light emitter 52 and the battery 16. Each of the conductors 56 may be an insulated wire or the like.

In use, the base 32 is attached to the body 14 of the wheelchair 12. The rod 20 is manipulated to position the light emitter 52 at a selected height. The switch 54 is manipulated to turn the light emitter 52 on. The light emitter 52 enhances visibility of the wheelchair 12 when the wheelchair 12 is crossing a roadway or the like. Thus, the light emitter 52 inhibits the wheelchair 12 from being struck by traffic when the wheelchair 12 is crossing the roadway.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wheelchair safety system comprising:
a wheelchair having a body and a battery; and
a light unit being coupled to said wheelchair wherein said light unit is configured to emit light thereby facilitating said light unit to notify traffic that the wheelchair is crossing a roadway, said light unit having a telescopically adjustable height wherein said light unit is configured to be visible to traffic.

2. The system according to claim 1, wherein said light unit comprises a rod having a first end and a second end, said rod comprising a first half being slidably coupled to a second half such that said rod has a telescopically adjustable height.

3. The system according to claim 2, further comprising a base having a first surface and a second surface, said base having a plurality of openings extending through said first surface and said second surface, said base having a collar extending upwardly from said first surface, said first end of said rod being positioned in said collar such that said rod is coupled to said base, said second surface abutting said body of said wheelchair.

4. The system according to claim 3, further comprising a plurality of fasteners, each of said fasteners extending through an associated one of said openings and engaging said body such that said base is retained on said wheelchair.

5. The system according to claim 1, further comprising a housing having a top wall, a bottom wall and an outer wall extending therebetween, said outer wall being continuous such that said housing has a cylindrical shape, said outer wall being comprised of a translucent material.

6. The system according to claim 5, wherein:
said light unit includes a rod having a second end; and
said bottom wall being coupled to said second end of said rod such that said housing is spaced a selected distance above said wheelchair wherein said rod is configured to enhance visibility of said housing with respect to the traffic.

7. The system according to claim 6, further comprising a light emitter being rotatably positioned within said housing wherein said light emitter is configured to emit light outwardly from said outer wall.

8. The system according to claim 7, further comprising a switch being coupled to said rod wherein said switch is configured to be manipulated, said switch being electrically coupled to said light emitter such that said switch turns said light emitter on and off.

9. The system according to claim 7, further comprising a pair of conductors, each of said conductors extending through said first end and said second end of said rod, each of said conductors being electrically coupled between said light emitter and said battery.

10. A wheelchair safety system comprising:
a wheelchair having a body and a battery; and
a light unit being coupled to said wheelchair wherein said light unit is configured to emit light thereby facilitating said light unit to notify traffic that the wheelchair is crossing a roadway, said light unit having a telescopically adjustable height wherein said light unit is configured to be visible to traffic, said light unit comprising:
a rod having a first end and a second end, said rod comprising a first half being slidably coupled to a second half such that said rod has a telescopically adjustable height,
a base having a first surface and a second surface, said base having a plurality of openings extending through said first surface and said second surface, said base having a collar extending upwardly from said first surface, said first end of said rod being positioned in said collar such that said rod is coupled to said base, said second surface abutting said body of said wheelchair,
a plurality of fasteners, each of said fasteners extending through an associated one of said openings and engaging said body such that said base is retained on said wheelchair,
a housing having a top wall, a bottom wall and an outer wall extending therebetween, said outer wall being continuous such that said housing has a cylindrical shape, said outer wall being comprised of a translucent material, said bottom wall being coupled to said second end of said rod such that said housing is spaced a selected distance above said wheelchair wherein said rod is configured to enhance visibility of said housing with respect to the traffic,
a light emitter being rotatably positioned within said housing wherein said light emitter is configured to emit light outwardly from said outer wall,
a switch being coupled to said rod wherein said switch is configured to be manipulated, said switch being electrically coupled to said light emitter such that said switch turns said light emitter on and off, and
a pair of conductors, each of said conductors extending through said first end and said second end of said rod, each of said conductors being electrically coupled between said light emitter and said battery.
